(19) United States
(12) Patent Application Publication
(10) Pub. No.: US 2024/0234717 A1
(43) Pub. Date: Jul. 11, 2024

(54) A PROCESS FOR PRODUCING CATHODE ACTIVE MATERIAL COMPOSITION FOR A LITHIUM-ION BATTERY

(71) Applicant: COUNCIL OF SCIENTIFIC & INDUSTRIAL RESEARCH, New Delhi (IN)

(72) Inventor: Prakash Annigere Sannalingegowda, Chennai (IN)

(21) Appl. No.: 18/558,761

(22) PCT Filed: May 2, 2022
(86) PCT No.: PCT/IN2022/050410

§ 371 Date: Nov. 3, 2023

(30) Foreign Application Priority Data
May 3, 2021 (IN) 202111020115

(51) Int. Cl. H01M 4/525; C01G 53/00; H01M 4/02; H01M 4/131; H01M 4/505; H01M 10/0525

(52) U.S. Cl. CPC H01M 4/525; C01G 53/50; H01M 4/131; H01M 4/505; H01M 10/0525; C01P 2002/52; C01P 2002/60; C01P 2002/72; C01P 2002/76; C01P 2004/03; C01P 2004/52; C01P 2004/53; C01P 2006/12; C01P 2006/40; H01M 2004/021; H01M 2004/028

(57) ABSTRACT

The present invention relates to the method for preparation of a cathode active material composition for a lithium-ion battery, which is cost-effective and time-effective. Another embodiment of the present invention is the cathode active material composition, Liₓ(Ni_{1-y-z}Mn_{y}Co_{z})₁₋ₐM′ₐO₂ (1.0≤x≤1.1, 0.25≤y≤0.3, 0.15≤z≤0.2, 0<a≤0.05, where M=Al, Ti, Cr, Fe or a combination thereof) which results in improved capacity and particle size distribution. In particular, this cathode active material composition can be produced in bulk and utilized for battery industries.

### FIELD OF THE INVENTION

The present invention relates to the method for preparation of a cathode active material composition through combustion for a lithium-ion battery, which is cost-effective and time-effective. Another embodiment of the present invention is the cathode active material composition, Liₓ(Ni_{1-y-z}Mn_{y}Co_{z})₁₋ₐM′ₐO₂ (1.0≤x≤1.1, 0.25≤y≤0.3, 0.15≤z≤0.2, 0<a≤0.05, where M=Al, Ti, Cr, Fe or a combination thereof) which results in improved capacity and particle size distribution. In particular, this cathode active material composition can be produced in bulk and utilized for battery industries.

### BACKGROUND OF THE INVENTION

At present, a Lithium-ion battery plays a major role in electric vehicles, portable and consumer electronics for its quick charging, improved life cycle and loading characteristics. In general, the Lithium-ion battery is composed of, a Lithium metal oxide-based cathode, a graphite anode, an electrolyte, and a separator. Presently, cathode active material compositions have been investigated extensively. Moreover, some of the compositions give good electrochemical performances and safety standards. However, due to low specific capacity and an increase in energy density demands these compositions will not meet the demands of the market.

Another problem is the production method. Conventional methods such as a precipitation, a co-precipitation, a sol-gel, a solid-state synthesis and a wet chemical for the preparation of the cathode active material composition are tedious and require prolonged heat treatment. There is thus a need for a method for preparing the cathode active material composition of the Lithium-ion battery in a cost-effective and time-efficient manner.

Reference CN109390553A discloses a process to synthesize a composite positive electrode material including a core and a shell layer. The shell layer is coated on the surface of the core. The general formula of the core is LiₙNiₓCo_{y}M_{z}NₘO₂, wherein 0.95≤n≤1.05, 0.5≤x<1, 0<y≤0.4, 0<z≤0.4, 0≤m≤0.05, and x+y+z+m=1, M is at least one selected from the group consisting of Mn and Al, and N is at least one selected from the group consisting of Mg, Ti, Zr, Nb, Y, Cr, V, Ge, and Mo. The shell layer has the general formula Li_{α}Co_{1-β}Ma_{β}O₂, wherein 1≤α≤1.08, 0≤β≤0.1, and Ma is at least one selected from the group consisting of Al, Mg, Nb, Ti, Zr, and V. The spherical positive electrode material LiNi_{0.5}Co_{0.2}Mn_{0.3}O₂ was added to the planetary ball mill for ball milling to break it into primary particles. The ball milling speed was 400 rpm, the ball milling time was 8 h, the ball-to-batch ratio was 3:1, and the ball milling medium was ethanol. After the end, it is dried, and then annealed at 850° C. for 10 hours in an oxygen atmosphere to obtain a core material; the molar ratio of Li:Co:Al=1:0.97:0.03 is accurately weighed in lithium acetate, cobalt acetate and aluminum isopropoxide, and then dissolved in ethanol. A certain amount of citric acid was added as a pH of the complexing agent regulator and stirring was continued to form a homogeneous mixed solution, and stirring was continued at 80° C. to form a uniform sol of the shell material. The core material is added to the sol, placed in a water bath at 80° C., continuously stirred to form a gel, and then vacuum-dried, followed by heat treatment. The heat treatment process is heat treatment at 900° C. for 20 h, cooling to 400° C. and then heat preservation for 4 h, all heat treatment processes are performed. It is carried out under an oxygen atmosphere. After the end of the heat preservation, the furnace is cooled and sieved to obtain a composite positive electrode material having a core-shell structure, wherein the core material is LiNi_{0.5}Co_{0.2}Mn_{0.3}O₂, the shell material is LiCo_{0.97}Al_{0.03}O₂.

Reference EP2012380B1 discloses a positive-electrode active material powder, which comprises a granular material (A) capable of doping/dedoping lithium ions and a deposit (B) placed on the surface of the material in a granular or layered form (herein, the material (A) and the deposit (B) are not the same), the percentage of [volumetric sum of particles having a particle diameter of 1 μm or less]/[volumetric sum of entire particles] being 5% or less. It is preferred that the percentage of [volumetric sum of particles having a particle diameter of 1 μm or less]/[volumetric sum of entire particles] is 3% or less, and more preferably 2% or less, so as to further increase the discharge capacity of the nonaqueous secondary battery. Herein, as the values of [volumetric sum of particles having a particle diameter of 1 μm or less] and [volumetric sum of entire particles], values measured by a particle diameter distribution analyzer using a laser diffraction scattering method are used.

Reference EP3100981A1 discloses the method for producing the nickel cobalt complex hydroxide. This disclosure is a method for producing the complex hydroxide by a crystallization reaction, the method can include a first crystallization in that a solution including nickel, cobalt and manganese, a solution of a complex ion forming agent, and a basic solution are supplied separately and simultaneously to one reaction vessel to obtain nickel cobalt complex hydroxide particles, and a second crystallization in that after the first crystallization, the solution containing nickel, cobalt and manganese, the solution of the complex ion forming agent, the basic solution, and a solution containing the element M are further separately and simultaneously supplied to the reaction vessel to crystallize complex hydroxide particles containing nickel, cobalt, manganese, and the element M on the nickel cobalt complex hydroxide particles.

Reference CN103400979 provides a self-propagating combustion decomposition method for preparing a lithium ion battery electrode material and especially for preparing a LiₐNiₓCo_{y}Mn_{z}O₂ material. The self-propagating combustion decomposition method comprises the following steps: (1) dissolving soluble lithium, nickel, cobalt and manganese compounds in deionized water to an atom mole ratio of LiₐNiₓCo_{y}Mn_{z}O₂. (2) carrying out stirring electric-heating of the mixed solution obtained by the step-1 to a temperature of 200-600° C. so that the mixed solution undergoes a full reaction and self-propagating combustion decomposition, and (3) compacting the combustion decomposition product obtained by the Step 2, putting the compacted combustion decomposition product into a high temperature furnace, carrying out sintering at a temperature of 850-900° C. for 8-24 h, and carrying out natural cooling to a room temperature so that the LiₐNiₓCo_{y}Mn_{z}O₂ material is obtained.

Reference JP2008305777A shows a method for producing a lithium transition metal-based compound powder for a lithium secondary battery positive electrode material. At least one transition metal compound selected from Mn, Fe, Co, Ni, and Cu and an additive that suppresses grain growth and sintering during firing in a liquid medium and uniformly A slurry preparation step for obtaining a slurry dispersed in the slurry, a spray drying step for spray drying the obtained slurry, and a firing step for firing the obtained spray dried powder.

Reference U.S. Pat. No. 7,507,501B2 discloses the method for the preparation of positive active material composition of rechargeable lithium batteries. 5 g of Al-isopropoxide powder was mixed with 95 g of ethanol, and the resultant mixture was stirred for about 4 hours to provide a white, milky Al-isopropoxide suspension. The suspension was dried in an oven at 100° C. for 10 hours to obtain a white Al(OH)₃ powder. A LiCoO₂ powder positive active material, the resulting Al(OH)₃ powder, a carbon conductor, and a polyvinylidene fluoride binder were mixed in the weight ratio of 93.5:0.5:3:3 with a N-methyl pyrrolidone solvent to obtain a positive active material slurry.

Reference patent US2019036117A1 discloses A positive active material for a lithium ion battery, comprising a first lithium transition metal oxide represented by formula Liₐ(Ni_{b}Co₀Mn_{d})₁₋ₑMₑO₂ or Liₐ(Ni_{b}Co_{c}Al_{d})₁₋ₑM′ₑO₂, wherein 0.9 a second lithium transition metal oxide represented by formula LiₓNi_{y}Co_{z}M″ₛO₂, wherein 0.9<x<1.1, 0.4≤y<0.6, 0.2≤z<0.5, 0.2≤s<0.5, y+z+s=1, M″ is at least one of Mn, Al, Mg, Ti, Zr, Fe, Cr, V, Ti, Cu, B, Ca, Zn, Nb, Mo, Sr, Sb, W, Bi.

Reference patent IN201817027882 describes a positive electrode for a secondary battery, comprising 1) a positive electrode current collector (a first positive electrode mixture layer laminated on the positive electrode current collector and including a first positive active material and a first conductive material; 2) a second positive electrode mixture layer laminated on the first positive electrode mixture layer and including a second positive electrode active material and a second conductive material. It claims that at least one of the first positive electrode active material and the second positive electrode active material comprises a lithium transition metal oxide represented by LiₐNi_{1-x-y}CoₓMn_{y}M_{z}O₂, where M is any one or more elements selected from the group consisting of Al, Zr, Ti, Mg, Ta, Nb, Mo and Cr, and 0.9≤a≤1.5, 0≤x≤0.5, 0≤y≤0.5, 0≤z≤0.1 and 0≤x+y≤0.7.

Reference IN201717008139 discloses a nonaqueous battery and a battery pack, where the positive electrode includes an active material containing LiₓNi_{1-a-b}CoₐMn_{b}M_{c}O₂ (0.9<x≤1.25, 0<a≤0.4, 0≤b≤0.45, 0≤c≤0.1, and M represents at least one element selected from the group consisting of Mg, Al, Si, Ti, Zn, Zr, Ca, and Sn).

Reference WO2017094416A1 relates to a positive electrode active material for a lithium secondary battery, and a manufacturing method thereof. Positive electrode active material for Lithium secondary battery coating forming liquid added with Lithium transition metal composite oxide (Li_{1.26}Fe_{0.11}Ni_{0.11}Mn_{0.52}O₂) was allowed to stand at 80° C. for 3 hours instead of leaving it at 60° C. for 3 hours, a coated positive electrode active material was obtained in the same manner as in Synthesis Example 1. The coating amount (bonding amount) of the lithium metaphosphate to the positive electrode active material was 0.8% by mass.

Reference CN103730635 relates to a combustion method for preparing a Li_{1.1}Ni_{0.5}Co_{0.2}Mn_{0.3}O₂ lithium ion battery electrode material. The method comprises the following steps that 1, an intermediate product is prepared by mixing nickel acetate, cobalt acetate and manganese acetate then mixed with lithium acetate and citric acid. To the obtained mixture alcohol is added and ground. The obtained slurry is put into a muffle furnace or a pushed slab kiln at 600° C. until complete combustion, and then calcined at 900° C. 10 h to obtain a product and then cooled along with the furnace.

### Objective of the Invention

The main objective of the present invention is to provide a method for producing cathode active material composition for a lithium-ion battery which obviates the drawbacks of the hitherto known prior art as detailed above.

Another objective of the present invention is to provide a cathode active material composition as Liₓ(Ni_{1-y-z}Mn_{y}Co_{z})₁₋ₐM′ₐO₂, where M is a dopant, combination of one or two metals, with low stoichiometry (0<a≤0.05) by a combustion method. Present invention disclosed the cathode active material which is doped with a one or two metals among Al, Ti, Cr and Fe of concentrations lesser than 0.05.

Still another objective of the present invention is to provide the production methodology for cathode active material composition, called combustion which has several advantages such as simple, cost-effective, quick process and easy for bulk production.

### SUMMARY OF THE INVENTION

Present invention provides a method for producing cathode active material composition for a lithium-ion battery which comprising the steps of: dissolving precursors (102) in deionized water (104) in a container (110) to form a precursor solution, wherein the precursors (102) are metal-nitrate precursors; stirring the precursor solution in the container (110), wherein the precursor solution filled in the container (110) is heated at a range of 60° C.-100° C.; adding organic amides and amino acids into the precursor solution to form a homogeneous solution in the container (110); pouring the obtained homogenous solution into a crucible (116) for performing combustion at a temperature in a range of 600° C.-1000° C. for a predefined time of 1 minute to 30 minutes to obtain a sample; grinding the obtained sample for a predefined time of 10 minutes to 10 hours by a grinding unit after a cool down of the sample; and sintering the ground sample at a predetermined temperature in a range of 600° C.-1000° C. for a predefined time of 1 hour-24 hours to obtain the cathode active material composition (100).

Embodiments in accordance with the present invention provide a method for preparation of a cathode active material composition (100). The method comprising the steps of dissolving precursors in deionized water in a container to form a precursor solution. In an embodiment of the present invention, the precursors are metal-nitrate precursors. The method further comprising the steps of stirring the precursor solution in the container. In an embodiment of the present invention, the precursor solution filled in the container is heated at a range of 60° C.-100° C. The method further comprising the steps of adding organic amides and amino acids into the precursor solution to form a homogeneous solution in the container. The method further comprising the steps of pouring the obtained homogenous solution into a crucible for performing combustion at a temperature in a range of 600° C.-1000° C. for a predefined time of 1 minute to 30 minutes to obtain a sample. The method further comprising the steps of grinding the obtained sample for a predefined time of 10 minutes to 10 hours by a grinding unit after a cool down of the sample. The method further comprising the steps of sintering the ground sample at a predetermined temperature in a range of 600° C.-1000° C. for a predefined time of 1 hour-24 hours to obtain the cathode active material composition.

In yet another embodiment of the present invention, wherein cathode composition for a Lithium-ion battery having a formula Liₓ(Ni_{1-y-z}Mn_{y}Co_{z})₁₋ₐM′ₐO₂ and 1.0≤x≤1.1, 0.25≤y≤0.3, 0.15≤z≤0.2, 0<a≤0.05. The element M′ can be selected from Titanium (Ti), Aluminum (Al), Chromium (Cr), Iron (Fe), and so forth. The cathode composition includes particles having a size distribution of the particles between 0.766 μm to 517.200 μm and a specific capacity ranging from 150 mAh/g to 161 mAh/g. In an embodiment of the present invention, the particles size distribution comprises a median size (D₅₀) indicating 50% of the particles in the sample lesser than 71.1594 μm and the remaining 50% greater. The cathode composition further includes particles having a size distribution of the particles between 0.339 μm to 200 μm and a specific capacity ranging from 140 mAh/g to 160 mAh/g. In an embodiment of the present invention, the particles size distribution comprises a median size (D₅₀) indicating 50% of the particles in the sample lesser than 5.6148 μm and the remaining 50% greater. The cathode composition further includes particles having a size distribution of the particles between 0.58 μm to 29.907 μm and a specific capacity ranging from 148 mAh/g to 155 mAh/g. In an embodiment of the present invention, the particles size distribution comprises a median size (D₅₀) indicating 50% of the particles in a sample lesser than 8.6573 μm and the remaining 50% greater. The cathode composition further includes particles having a size distribution of the particles between 0.296 μm to 262.376 μm and a specific capacity ranging from 148 mAh/g to 155 mAh/g. In an embodiment of the present invention, the particles size distribution comprises a median size (D₅₀) indicating 50% of the particles in the sample lesser than 20.7721 μm and the remaining 50% greater.

In yet another embodiment of the present invention, wherein Lithium-ion battery that includes a cathode obtained by coating a blended slurry of active material conducting carbons and a binder in a N-Methyl-2-Pyrrolidone (NMP) solvent on an Aluminum foil. The Lithium-ion battery further includes an anode. The Lithium-ion battery further includes an electrolyte for lithium-ion conduction. The Lithium-ion battery further includes a separator to isolate the cathode and the anode placed in the electrolyte. In an embodiment of the present invention, the separator includes a first surface configured to be in contact with the cathode. The separator further includes a second surface configured to be in contact with the anode.

In yet another embodiment of the present invention, wherein number of advantages depending on its particular configuration. First, embodiments of the present application provide a method for preparing a cathode active material composition in Lithium-ion battery. Next, embodiments of the present application aim at developing a low-cost Lithium-ion battery.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a schematic representation for preparation of a cathode active material composition, with respect to the embodiments of the present invention disclosed herein;

FIG. 2 illustrates a schematic representation of a Lithium-ion battery,

FIG. 3A illustrates an X-ray diffraction pattern of LiNi_{0.5}Mn_{0.25}Co_{0.2}Al_{0.025}Ti_{0.025}O₂ cathode active material composition;

FIG. 3B illustrates an X-ray diffraction pattern of LiNi_{0.5}Mn_{0.25}Co_{0.2}Ti_{0.05}O₂ cathode active material composition;

FIG. 3C illustrates an X-ray diffraction pattern of LiNi_{0.5}Mn_{0.25}Co_{0.2}Fe_{0.05}O₂ cathode active material composition;

FIG. 3D illustrates an X-ray diffraction pattern of LiNi_{0.5}Mn_{0.25}Co_{0.2}Cr_{0.05}O₂ cathode active material composition;

FIG. 4A illustrates a FESEM image of LiNi_{0.5}Mn_{0.25}Co_{0.2}Al_{0.025}Ti_{0.025}O₂ cathode active material composition;

FIG. 4B illustrates a FESEM image of LiNi_{0.5}Mn_{0.25}Co_{0.2}Ti_{0.05}O₂ cathode active material composition;

FIG. 4C illustrates a FESEM image of LiNi_{0.5}Mn_{0.25}Co_{0.2}Fe_{0.05}O₂ cathode active material composition;

FIG. 4D illustrates a FESEM image of LiNi_{0.5}Mn_{0.25}Co_{0.2}Cr_{0.05}O₂ cathode active material composition;

FIG. 5A illustrates a particle size distribution of the LiNi_{0.5}Mn_{0.25}Co_{0.2}Al_{0.025}Ti_{0.025}O₂ active cathode material composition;

FIG. 5B illustrates a particle size distribution of the LiNi_{0.5}Mn_{0.25}Co_{0.2}Ti_{0.05}O₂ active cathode material composition, with respect to the embodiments of the present invention disclosed herein;

FIG. 5C illustrates a particle size distribution of the LiNi_{0.5}Mn_{0.25}Co_{0.2}Fe_{0.05}O₂ active cathode material composition;

FIG. 5D illustrates a particle size distribution of the LiNi_{0.5}Mn_{0.25}Co_{0.2}Cr_{0.05}O₂ active cathode material composition;

FIG. 6 illustrates a Nitrogen adsorption-desorption isothermal plot of LiNi_{0.5}Mn_{0.25}Co_{0.2}Al_{0.025}Ti_{0.025}O₂;

FIG. 7A illustrates a Voltage-specific capacity plot of Lithium-half cells fabricated with LiNi_{0.5}Mn_{0.25}Co_{0.2}Al_{0.025}Ti_{0.025}O₂ cathode active material;

FIG. 7B illustrates a Voltage-specific capacity plot of Lithium-half cells fabricated with LiNi_{0.5}Mn_{0.25}Co_{0.2}Ti_{0.05}O₂ cathode material;

FIG. 7C illustrates a Voltage-specific capacity plot of Lithium-half cells fabricated with LiNi_{0.5}Mn_{0.25}Co_{0.2}Fe_{0.05}O₂ cathode active material;

FIG. 7D illustrates a Voltage-specific capacity plot of Lithium-half cells fabricated with LiNi_{0.5}Mn_{0.25}Co_{0.2}Cr_{0.05}O₂ cathode active material;

FIG. 8 illustrates a Voltage-specific capacity plot of Lithium-ion battery fabricated with LiNi_{0.5}Mn_{0.25}Co_{0.2}Ti_{0.05}O₂ cathode material; and

FIG. 9 illustrates a flowchart of a process for the preparation of an active cathode material composition.

### DETAILED DESCRIPTION OF THE INVENTION

The following description includes the preferred best mode of one embodiment of the present invention. It will be clear from this description of the invention that the invention is not limited to these illustrated embodiments but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) can be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

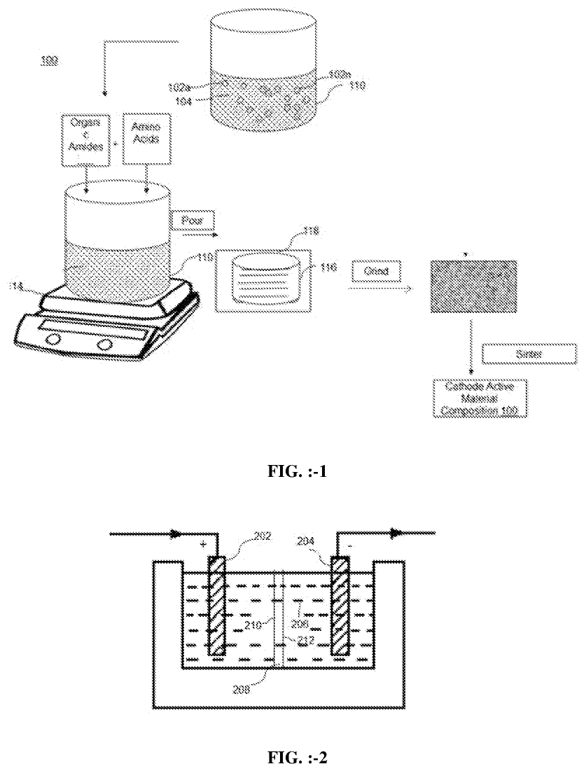

FIG. 1 illustrates a schematic representation for preparation of a cathode active material composition 100, as per the embodiments of the present invention. The active cathode material composition 100 comprises precursors 102a-102n (hereinafter referred to as the precursors 102), deionized water 104, organic amides and amino acids, with reference to an embodiment of the present invention.

Embodiments of the present invention describes the precursors 102 can be a compound that can participate in a chemical reaction to produce another compound. In the embodiments of the present invention, the precursors 102 can be, such as, but not limited to, molecular precursors, sol-gel precursors, carbon-based precursors, chemical precursors, and so forth. In preferred embodiments of the present invention, the precursors 102 can be metal-nitrate precursors. Embodiments of the present invention are intended to include or otherwise cover any type of the precursors 102 including known, related art, and/or later developed technologies. In the embodiments of the present invention, a required stoichiometric mole ratio of the metal-nitrate precursors can be, such as, but not limited to, Lithium precursors, Nickel precursors, Cobalt precursors, Titanium precursors, Manganese precursors, Iron precursors, Chromium precursors, Aluminum precursors, and so forth. Embodiments of the present invention are intended to include or otherwise cover any type of the metal-nitrate precursors including known, related art, and/or later developed technologies.

Further, the precursors 102 can be placed in a container 110 for stirring and heating so as to initiate the synthesis of the cathode active material composition 100. In the embodiments of the present invention, the container 110 can be made up of a material, such as, but not limited to, a ceramic, a glass, a steel, and so forth. Embodiments are intended to include or otherwise cover any material of the container 110, including known, related art, and/or later developed technologies.

Embodiments of the present invention also describes the deionized water 104 which treated water that has dissolved mineral salts and ions removed. The deionized water 104 used for dissolving precursors 102. In preferred embodiments of the present invention, the deionized water 104 is 20 ml. Embodiments of the present invention are intended to include or otherwise cover any amount of the deionized water 104 used in the preparation of the cathode active material composition 100. In an exemplary scenario, the precursors 102 of 5 g dissolved in 20 ml of the deionized water 104 for preparing a precursor solution in the container 110.

Further, the precursor solution prepared inside the container 110 placed on a hot plate 114. The precursor solution stirred continuously when placed over the hot plate 114. In a preferred embodiment of the present invention, the precursor solution filled in the container 110 heated at a range of 60° C.-100° C. Embodiments are intended to include or otherwise cover any heating range, including known, related art, and/or later developed technologies. In a preferred embodiment of the present invention, a temperature of the hot plate 114 is 80° C.-90° C. After, 15 minutes of continuous stirring fuels added to the precursor solution. As per embodiments of the present invention, the fuels that obtained from sources, such as, but not limited to, Amino acids, Polycarboxilic acids, Amides, and so forth. The embodiments of the present invention, uses the amino acids, such as but not limited to, an alanine, a glycine, a valine, a leucine, an isoleucine, and so forth. In a preferred embodiment of the present invention, the Polycarboxilic acids can be, such as, but not limited to, a citric acid, an oxalic acid, and so forth. As per the embodiments of the present invention, the amides, such as, but not limited to, urea, a carbohydrazide, an oxalyl dihydrazide, an acetamide, and so forth. Embodiments are intended to include or otherwise cover any type of fuels, including known, related art, and/or later developed technologies. In the preferred embodiment of the present invention, the fuel such as urea, glycine, or a combination thereof. In an exemplary scenario, the urea (80%) and the glycine (20%) is added into the precursor solution to form a homogeneous solution after few minutes of heating on the hot plate 114. As per the embodiments of the present invention, the precursor solution is heated using a heating apparatus, such as, but not limited to, a Bunsen burner, an electric heater, and so forth. Embodiments are intended to include or otherwise cover any type of the heating apparatus, including known, related art, and/or later developed technologies.

Embodiments of the present invention describes also the homogeneous solution which is poured into a crucible 116 for performing combustion at a predetermined temperature for a predefined time to obtain a sample. In an embodiment of the present invention, the predetermined temperature is greater than 600° C. In an embodiment of the present invention, the predefined time is three minutes. In an exemplary scenario, the homogeneous solution is poured into a crucible 116 for performing combustion in a furnace 118 at 800° C. for three minutes. The homogeneous solution is combusted so as to form a sample.

Embodiments are intended to include or otherwise cover any amount of predetermined temperature and the predefined time, including known, related art, and/or later developed technologies. As per the embodiments of the present invention, the crucible 116 is made up of a material, such as, but not limited to, a porcelain, a platinum, a stainless steel, an Alumina, a nickel, a vitreous carbon, a zirconium, and so forth. Embodiments are intended to include or otherwise cover any material of the crucible 116, including known, related art, and/or later developed technologies. As per the embodiments of the present invention, the combustion is taken place in a high temperature furnace 118 with +/−5° C. accuracy.

Further, the sample can be taken out of the crucible 116 and at a room temperature for cooling. Later, the obtained sample is ground for a predefined time by a grinding unit after a cool down of the sample. In the embodiments of the present invention, the grinding unit can be a mortar, a ball mill, a jet mill, a fluid energy mill, an air classifier mill, a pendulum mill, and so forth. In an embodiment of the present invention, the predefined time for the sample cool down can be 10-15 minutes. In a preferred embodiment of the present invention, the obtained sample can be ground manually using a mortar for 15 minutes. Further, the ground sample can be sintered at a predetermined temperature for a predefined time to obtain the cathode active material composition 100. In an embodiment of the present invention, the predetermined temperature can be greater than 800° C. In an embodiment of the present invention, the predefined time can be 12 hours. Furthermore, the grinding of the sample can be followed by sintering at 850° C. for 12 hours to obtain the cathode active material composition 100. Embodiments are intended to include or otherwise cover any amount of predetermined temperature and the predefined time, including known, related art, and/or later developed technologies.

In a preferred embodiment of the present invention, the cathode active material composition 100 can be characterized by performing characterizations. The characterizations type can be, such as but not limited to, an X-Ray Diffraction (XRD), a physicochemical characterization, and so forth. Embodiments are intended to include or otherwise cover any type of the characterizations, including known, related art, and/or later developed technologies. Further, a half-cell electrochemical analysis can be performed by mixing the conducting carbon (5%) and a binder (PVDF-5%) by hand grinding using a N-Methyl-2-Pyrrolidone (NMP) solvent to make a slurry. The binder is a Polyvinylidene fluoride (PVDF). Furthermore, the cathode 202 can be fabricated by preparing the slurry followed by coating. In an embodiment of the present invention, the slurry can be prepared by mixing the active material, the conducting carbon and the binder in the NMP solvent. Then the slurry is coated on an aluminum foil and dried at 70° C.-100° C. for 12 hours to obtain the cathode 202.

FIG. 2 illustrates a schematic representation of a Lithium-ion battery 200. The Lithium-ion battery 200 can also be known as an electrochemical cell that can provide a back-up power. The Lithium-ion battery 200 comprises a cathode 202, an anode 204, an electrolyte 206 and a separator 208. Further, the Lithium-ion battery 200 can be fabricated using cathode active material composition 100 in a glove box/dry room for shielding the Lithium-ion battery 200 from the outside environment. As per the embodiments of the present invention, the glove box can be an argon glove box. Embodiments are intended to include or otherwise cover any type of glove box/dry room, including known, related art, and/or later developed technologies.

In a preferred embodiment of the present invention, a coin cell can be fabricated either in the glove box under an inert atmosphere or dry room. Further, the performance of the material can be tested using the coin cell.

In the present invention, the cathode 202 is an electrode where electricity is given out/flows out. In an embodiment of the present invention, the precursors 102 of 5 g is dissolved in 20 ml of the deionized water 104 for preparing a precursor solution in the container 110. The precursor solution prepared inside the container 110 is placed on a hot plate 114. The precursor solution is stirred continuously when placed over the hot plate 114. In the present invention, the temperature of the hot plate 114 is 80° C. After, 15 minutes of continuous stirring fuels are added to the precursor solution. The organic amides and the amino acids are added into the precursor solution to form a homogeneous solution after few minutes of heating on the hot plate 114. In the embodiments of the present invention, the organic acids, such as but not limited to, an acetic acid, a citric acid, a uric acid, a malic acid, and so forth. Embodiments are intended to include or otherwise cover any type of the organic acids, including known, related art, and/or later developed technologies. In the embodiments of the present invention, the amino acids, such as but not limited to, an alanine, a glycine, a valine, a leucine, an isoleucine, and so forth. Embodiments are intended to include or otherwise cover any type of the amino acids, including known, related art, and/or later developed technologies.

In a preferred embodiment of the present invention, the homogeneous solution is poured into a crucible 116 for performing combustion at a predetermined time to obtain the sample. In the embodiments of the present invention, the predetermined time is greater than 600° C. for three minutes. The homogeneous solution is combusted so as to form a sample. Embodiments are intended to include or otherwise cover any combustion temperature and time, including known, related art, and/or later developed technologies.

In a preferred embodiment of the present invention, the crucible 116 is made up of a material, such as, but not limited to, a porcelain, a platinum, a stainless steel, a nickel, a vitreous carbon, a zirconium, and so forth. Embodiments are intended to include or otherwise cover any material of the crucible 116, including known, related art, and/or later developed technologies. The sample is taken out of the crucible 116 and kept at room temperature for cooling. In an embodiment of the present invention, the sample is cooled down for 10-15 minutes. The obtained sample is ground manually using a mortar for 15 minutes. Further, the grinding of the sample followed by sintering at 850° C. for 12 hours to obtain an active cathode material composition 100, in an embodiment of the present invention.

Furthermore, the cathode 202 is obtained by coating the blended slurry of active material, conducting carbons and a binder in a N-Methyl-2-Pyrrolidone (NMP) solvent on the Aluminum foil. As per the embodiments of the present invention, the binder is a Polyvinylidene fluoride (PVDF) binder. In a preferred embodiment of the present invention, the cathode 202 is fabricated by preparing the slurry followed by coating. In an embodiment of the present invention, the slurry is prepared by mixing the active material, the conducting carbon and the binder in the NMP solvent. Then the slurry is coated on an aluminum foil and dried at 70° C.-100° C. for 12 hours to obtain the cathode 202.

In a preferred embodiment of the present invention, the lithium-ion battery 200 includes the cathode 202 as a positive terminal and the anode 204 as a negative terminal. In an embodiment of the present invention, when an input potential is applied, the lithium ions move from the cathode 202 to the anode 204 while charging. In an embodiment of the present invention, the lithium ions move from anode 204 to cathode 202 while discharging.

In a preferred embodiment of the present invention, the electrolyte 206 is employed for conducting lithium ions. The electrolyte 206 is absorbed into the separator 208 that is compressed against the cathode 202 and the anode 204 to achieve a chemical reaction. In the embodiments of the present invention, the electrolyte 206 is a solution of lithium hexafluorophosphate (LiPF₆) in organic solvents. Embodiments are intended to include or otherwise cover any type of the electrolyte 206, including known, related art, and/or later developed technologies.

In a preferred embodiment of the present invention, the separator 208 is employed for isolating the cathode 202 and the anode 204 placed in the electrolyte 206. The separator 208 comprise a first surface 210 and a second surface 212. In an embodiment of the present invention, the first surface 210 of the separator is configured to be in contact with the cathode 202. In an embodiment of the present invention, the second surface 212 of the separator is configured to be in contact with the anode 204. Although ions pass freely between electrodes 202-204, the separator 208 is an isolator with no electrical conductivity. In an embodiment of the present invention, the separator 208 can be a glass microfibre, polymer sheet, and so forth. In the embodiments of the present invention, the glass microfibre can be a glass microfibre. Embodiments are intended to include or otherwise cover any type of the separator 208, including known, related art, and/or later developed technologies. Furthermore, the separator 208 is porous in nature. In the present invention, the separator 208 is made up of a material, such as, but not limited to, polyolefin films, a nylon, a polypropylene, a glass fiber mat, a cellulose, a polyethylene plastic, and so forth. Embodiments are intended to include or otherwise cover any type of material for the separator 208, including known, related art, and/or later developed technologies.

In a preferred embodiment of the present invention, the cathode composition 100 for the Lithium-ion battery 200 comprise a formula Liₓ(Ni_{1-y-z}Mn_{y}Co_{z})₁₋ₐM′ₐO₂. In the present invention, the element M′ concentration “a” is 0<a≤0.05. In the present invention, the x concentration ranges from 1.0 to 1.1 and the y concentration ranges from 0.25 to 0.3. As per the embodiments of the present invention, the z concentration ranges from 0.15 to 0.2. In the embodiments of the present invention, the element M′ selected from Titanium (Ti), Aluminum (Al), Chromium (Cr), Iron (Fe), and so forth. Embodiments are intended to include or otherwise cover any element M′, including known, related art, and/or later developed technologies. As per the embodiments of the present invention, the element M′ is selected from Al Ti, Fe Ti, Cr Ti, Cr Al, Cr Fe, Fe Al, or a combination thereof.

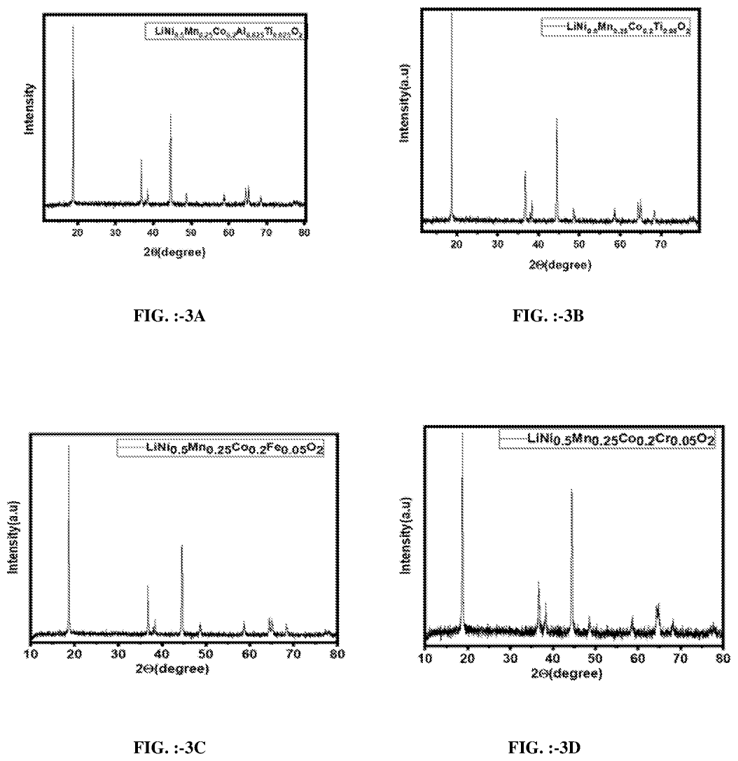

FIG. 3A illustrates an X-ray diffraction pattern of LiNi_{0.5}Mn_{0.25}Co_{0.2}Al_{0.025}Ti_{0.025}O₂ the active cathode material composition, as per the embodiments of the present invention. Here, X-ray diffraction (XRD) is a quick method to identify the formation of the required LiNi_{0.5}Mn_{0.25}Co_{0.2}Al_{0.025}Ti_{0.025}O₂ active cathode material composition phase through a crystal structure analysis. In an embodiment of the present invention, the active cathode material composition 100 is characterized by performing an X-Ray Diffraction (XRD) and the diffraction peaks correspond to a layered compound, and no other impurity peaks are observed. The high intense peaks confirm that the active cathode material composition 100 is crystalline. In an embodiment of the present invention, a clear splitting of the diffraction peaks around 65° indicate the ordered and layered compound with a minimum cation disorder. Further, the peaks match with the reference patterns of the cathode active material composition 100. The cathode active material composition 100 belong to a rhombohedral crystal system. The cathode active material composition 100 is a layered crystal structure with a crystal space group of R3̅m. The crystalline size of the particles of the cathode active material composition 100 ranges from 60 nm to 70 nm. In a preferred embodiment of the present invention, the estimated crystalline size is 64.31 nm.

FIG. 3B illustrates an X-ray diffraction pattern of LiNi_{0.5}Mn_{0.25}Co_{0.2}Ti_{0.05}O₂ the active cathode material composition, as per the embodiments of the present invention. In an embodiment of the present invention, the diffraction peaks correspond to a layered compound, and no other impurity peaks are observed. The high intense peaks confirm that the cathode active material composition 100 is crystalline and the clear splitting of the diffraction peaks around 65° indicate the ordered and layered compound with minimum cation disorder. Further, the peaks match with the reference patterns of cathode active material composition 100. The embodiments of the present invention, the cathode active material composition 100 belongs to a rhombohedral crystal system. The cathode active material composition 100 is a layered crystal structure with a crystal space group of R3̅m. The crystalline size of the particles of the cathode active material composition 100 ranges from 60 nm to 70 nm. In a preferred embodiment of the present invention, the estimated crystalline size is 65.96 nm.

FIG. 3C illustrates an X-ray diffraction pattern of LiNi_{0.5}Mn_{0.25}Co_{0.2}Fe_{0.05}O₂ the active cathode material composition, as per the embodiments of the present invention. Further, the diffraction peaks correspond to a layered compound, and no other impurity peaks are observed. The high intense peaks confirm that the material is crystalline and the clear splitting of the diffraction peaks around 65° indicate the ordered and layered compound with a minimum cation disorder. Furthermore, the peaks are perfectly matching with the reference patterns of the cathode active material composition 100. The cathode active material composition 100 belongs to a rhombohedral crystal system. The cathode active material composition 100 is a layered crystal structure with a crystal space group of R3̅m. The embodiments of the present invention, a crystalline size of the particles of the cathode active material composition 100 ranges from 60 nm to 70 nm. In a preferred embodiment of the present invention, the estimated crystalline size is 61.63 nm.

FIG. 3D illustrates an X-ray diffraction pattern of LiNi_{0.5}Mn_{0.25}Co_{0.2}Cr_{0.05}O₂ the active cathode material composition, with respect to embodiments of the present invention. Further, the diffraction peaks correspond to a layered compound, and no other impurity peaks are observed. The high intense peaks confirm that the material is crystalline and the clear splitting of the diffraction peaks around 650 indicate the ordered and layered compound with a minimum cation disorder. Furthermore, the peaks are perfectly matching with the reference patterns of the cathode active material composition 100. The cathode active material composition 100 belong to a rhombohedral crystal system. The cathode active material composition 100 is a layered crystal structure with a crystal space group of R3̅m. The embodiments of the present invention, a crystalline size of the particles of the cathode active material composition 100 ranges from 60 nm to 70 nm. In a preferred embodiment of the present invention, the estimated crystalline size is 66.63 nm.

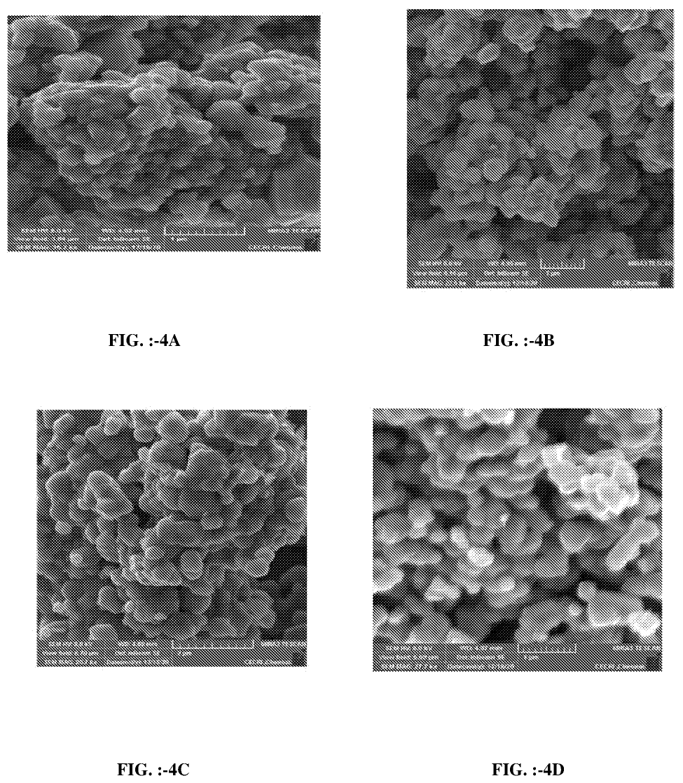

FIG. 4A illustrates a FESEM image of LiNi_{0.5}Mn_{0.25}Co_{0.2}Al_{0.025}Ti_{0.025}O₂ cathode active material composition 100, with reference to embodiments of the present invention. In the FIG. 4A, the morphology of LiNi_{0.5}Mn_{0.25}Co_{0.22}Al_{0.025}Ti_{0.025}O₂ sample is investigated by the Field Emission Scanning Electron Microscope (FESEM). In an embodiment of the present invention, micrographs show that the morphologies of the combustion-synthesized sample produce aggregated particles. Further, the sample is composed of different morphologies such as, but not limited to, hexagons, cubes, spheres, elongated hexagons, and so forth. Embodiments are intended to include or otherwise cover any type of morphologies, including known, related art, and/or later developed technologies.

FIG. 4B illustrates a FESEM image of LiNi_{0.5}Mn_{0.25}Co_{0.2}Ti_{0.05}O₂ cathode active material composition 100, with respect to embodiments of the present invention. In the FIG. 4B, the morphology of LiNi_{0.5}Mn_{0.25}Co_{0.2}Ti_{0.05}O₂ sample is investigated by the FESEM. In an embodiment of the present invention, micrographs show that the morphologies of the combustion-synthesized sample produce aggregated particles. Further, the sample is composed of different morphologies such as, but not limited to, hexagons, cubes, spheres, elongated hexagons, and so forth. Embodiments are intended to include or otherwise cover any type of morphologies, including known, related art, and/or later developed technologies.

FIG. 4C illustrates a FESEM image of LiNi_{0.5}Mn_{0.25}Co_{0.2}Fe_{0.05}O₂ cathode active material composition 100, with reference to embodiments of the present invention. In FIG. 4C, the morphology of LiNi_{0.5}Mn_{0.25}Co_{0.2}Fe_{0.05}O₂ sample is investigated by the FESEM. In an embodiment of the present invention, micrographs show that the morphologies of the combustion-synthesized sample produce aggregated particles. Further, the sample be composed of different morphologies such as, but not limited to, hexagons, cubes, spheres, elongated hexagons, and so forth. Embodiments are intended to include or otherwise cover any type of morphologies, including known, related art, and/or later developed technologies.

FIG. 4D illustrates a FESEM image of LiNi_{0.5}Mn_{0.25}Co_{0.2}Cr_{0.05}O₂ cathode active material composition 100, with reference to embodiments of the present invention. In the FIG. 4D, the morphology of LiNi_{0.5}Mn_{0.25}Co_{0.2}Cr_{0.05}O₂ sample is investigated by the FESEM. In an embodiment of the present invention, micrographs show that the morphologies of the combustion-synthesized sample produce aggregated particles. Further, the sample be composed of different morphologies such as, but not limited to, hexagons, cubes, spheres, elongated hexagons, and so forth. Embodiments are intended to include or otherwise cover any type of morphologies, including known, related art, and/or later developed technologies.

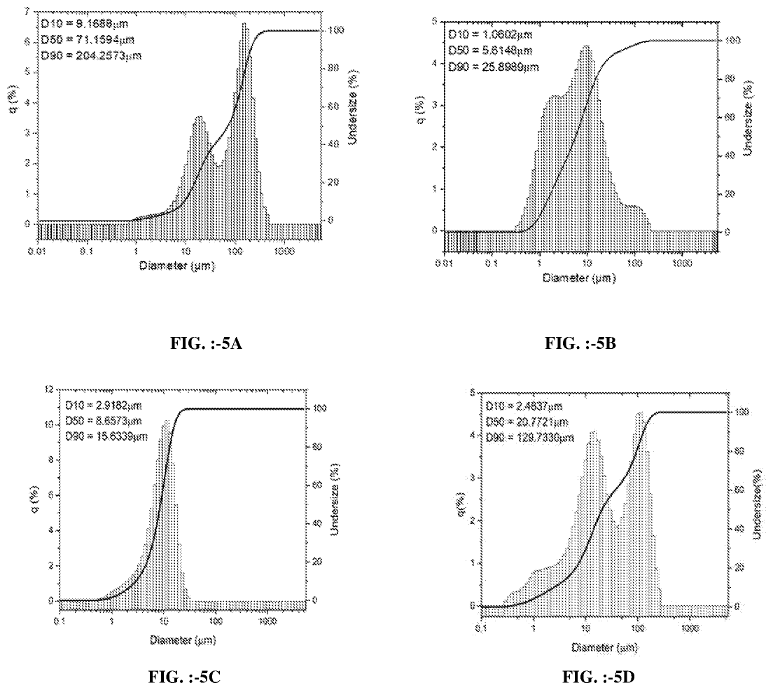

FIG. 5A illustrates a particle size distribution of the LiNi_{0.5}Mn_{0.25}Co_{0.2}Al_{0.025}Ti_{0.025}O₂ active cathode material composition, with respect to embodiments of the present invention. The plot as shown in FIG. 5A shows the size distribution of the particles that in the range of 0.766 μm to 517.200 μm. Analyzing further, the median size (D₅₀) indicate that 50% of the particles in the sample are lesser than 71.1594 μm and the remaining 50% are greater. Besides, the graph reveals that 10% of the population lies below 9.1688 μm (D₁₀) and 90% of the population lies below 204.2573 μm (D₉₀). The D₅₀ ranges from 5 μm to 80 μm and the D₉₀ ranges from 15 μm to 205 μm.

FIG. 5B illustrates a particle size distribution of the LiNi_{0.5}Mn_{0.25}Co_{0.2}Ti_{0.05}O₂ active cathode material composition, with reference to embodiments of the present invention. The plot as shown in FIG. 5B shows the size distribution of particles is in the range of 0.339 μm to 200 μm. Analyzing further, the median size (D₅₀) indicates that 50% of the particles in the sample are lesser than 5.6148 μm and the remaining 50% are greater. Besides, the graph reveals that 10% of the population lies below 1.062 μm (D₁₀) and 90% of the population lies below 25.8989 μm (D₉₀). The D₁₀ ranges from 1 μm to 10 μm.

FIG. 5C illustrates a particle size distribution of the LiNi_{0.5}Mn_{0.25}Co_{0.2}Fe_{0.05}O₂ active cathode material composition, with reference to embodiments of the present invention. In an embodiment of the present invention, a laser diffraction method is used for measuring a particle diameter of the cathode active material composition 100. The plot as shown in FIG. 5C shows the size distribution of particles in the range of 0.58 μm to 29.907 μm. Analyzing further, the median size (D₅₀) indicates that 50% of the particles in the sample are lesser than 8.6573 μm and the remaining 50% are greater. Besides, the graph reveals that 10% of the population lies below 2.9182 μm (D₁₀) and 90% of the population lies below 15.6339 μm (D₉₀).

FIG. 5D illustrates a particle size distribution of the LiNi_{0.5}Mn_{0.25}Co_{0.2}Cr_{0.05}O₂ active cathode material composition, as per the embodiments of the present invention. The plot as shown in FIG. 5D shows the size distribution of particles is in the range of 0.296 μm to 262.376 μm. Analyzing further, the median size (D₅₀) indicate that 50% of the particles in the sample are lesser than 20.7721 μm and the remaining 50% are greater, as per the embodiments of the present invention. Besides, the graph reveals that 10% of the population lies below 2.4837 μm (D₁₀) and 90% of the population lies below 129.7330 μm (D₉₀).

FIG. 6 illustrates a Nitrogen adsorption-desorption isothermal plot of LiNi_{0.5}Mn_{0.25}Co_{0.2}Al_{0.025}Ti_{0.025}O₂, with respect to embodiments of the present invention. The Nitrogen adsorption process have a kinetic behavior and the rate of arrival of adsorption is equal to the rate of desorption. In an embodiment of the present invention, an equilibrium adsorption capacity is measured under a certain pressure. The surface adsorption capacity of nitrogen on a surface depends on a nitrogen relative pressure (P/P₀), where P is a partial pressure of nitrogen and P₀ is a saturated vapor pressure of Nitrogen under the temperature of liquid nitrogen. Further, the nitrogen adsorption at a low temperature measures a specific surface area distribution of the cathode active material composition 100. The variation of pore size distribution is a result in the change of the specific surface area. The adsorption-desorption plot of the LiNi_{0.5}Mn_{0.25}Co_{0.2} Al_{0.025} Ti_{0.025}O₂ is to measure the surface area. The surface area is related to parameters such as but not limited to, a particle size, a particle shape, a particle texture, a particle porosity, and so forth. The embodiments of the present invention, as the pressure increases nitrogen adsorption increases and in turn surface area increases. Furthermore, when the pressure decreases, desorption occurs. In this embodiment of the present invention, a surface area of the particles of the composition ranges from 1 m²/g to 10 m²/g. A surface area of one of the particles of the composition is 5.4 m²/g.

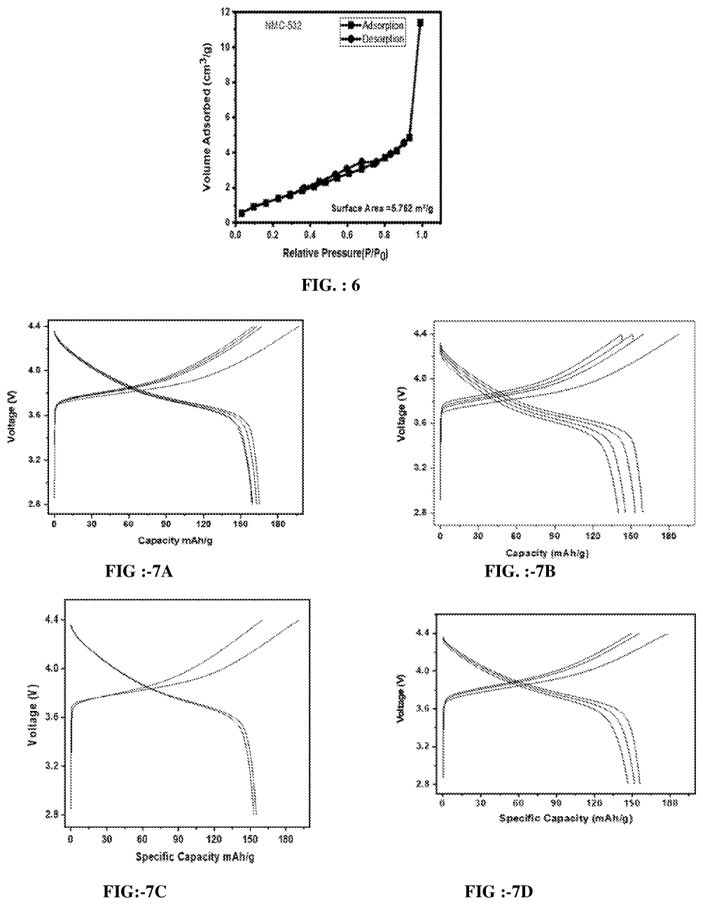

FIG. 7A illustrates Voltage-specific capacity plot of Lithium-half cells fabricated with LiNi_{0.5}Mn_{0.25}Co_{0.2}Al_{0.025}Ti_{0.025}O₂ cathode material, as per embodiments of the present invention. In the embodiments of the present invention, the voltage-specific capacity plot helps to determine the energy storage capacity of the cathode active material composition 100. In the embodiments of the present invention, the specific capacity is in between 150 mAh/g to 161 mAh/g under a voltage window ranging from 2.8V to 4.4V at a C/5 rate.

FIG. 7B illustrates Voltage-specific capacity plot of Lithium-half cells fabricated with LiNi_{0.5}Mn_{0.25}Co_{0.2}Ti_{0.05}O₂ cathode material, as per embodiments of the present invention. In the embodiments of the present invention, the voltage-specific capacity plot helps to determine the energy storage capacity of the cathode active material composition 100. The specific capacity is in between 140 mAh/g to 160 mAh/g under a voltage window ranging from 2.8V to 4.4V at a C/5 rate.

FIG. 7C illustrates Voltage-specific capacity plot of Lithium-half cells fabricated with LiNi_{0.5}Mn_{0.25}Co_{0.2}Fe_{0.05}O₂ cathode material, as per embodiments of the present invention. In the embodiments of the present invention, the voltage-specific capacity plot helps to determine the energy storage capacity of the cathode active material. The specific capacity have a range of 150 mAh/g to 155 mAh/g under a voltage window ranging from 2.8V to 4.4V at a C/5 rate.

FIG. 7D illustrates Voltage-specific capacity plot of Lithium-half cells fabricated with LiNi_{0.5}Mn_{0.25}Co_{0.2}Cr_{0.05}O₂ cathode material, to embodiments of the present invention. In the embodiments of the present invention, the voltage-specific capacity plot helps to determine the energy storage capacity of the cathode active material. In the embodiments of the present invention, the specific capacity is in between 148 mAh/g to 155 mAh/g under a voltage window ranging from 2.8V to 4.4V at a C/5 rate.

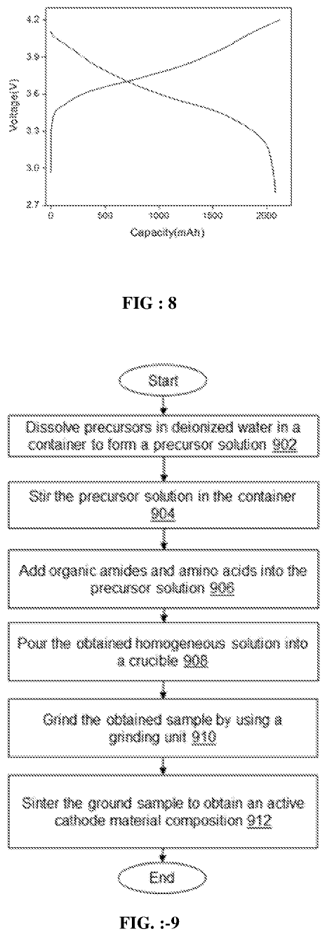

FIG. 8 illustrates a Voltage-specific capacity plot of Lithium-ion battery fabricated with LiNi_{0.5}Mn_{0.25}Co_{0.2}Ti_{0.05}O₂ cathode material, as per the embodiments of the present invention. FIG. 8 shows the voltage-specific capacity plot of the Lithium-ion battery fabricated with the LiNi_{0.5}Mn_{0.25}Co_{0.2}Ti_{0.05}O₂ cathode material. In the embodiments of the present invention, the specific capacity values range from 2000 mAh/g to 2100 mAh/g under the voltage window ranging from 2.8 V to 4.3V at C/5 rate.

FIG. 9 illustrates a flowchart of a process 900 for preparation of the active cathode material composition, as per the embodiment of the present invention.

At step 902, the precursors 102 is dissolved in deionized water 104 in a container 110 to form a precursor solution. In an embodiment of the present invention, the precursors 102 are metal-nitrate precursors.

At step 904, the precursor solution is stirred in the container 110. In an embodiment of the present invention, the precursor solution filled in the container 110 is heated using the hot plate 114 at 80° C.

At step 906, the urea and the glycine is added after 15 minutes of heating into the precursor solution to form a homogenous solution in the container 110.

At step 908, the obtained homogeneous solution is poured into a crucible 116 for performing combustion at 800° C. for three minutes to synthesize the sample.

At step 910, the obtained sample is cooled at room temperature. Further, the cooled sample is ground for 15 minutes by using the mortar.

At step 912, the ground sample is sintered at 850° C. for 12 hours to obtain the cathode active material composition.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

### EXAMPLES

The following examples are given by way of illustration of the working of the invention in actual practice and therefore should not be construed to limit the scope of the present invention.

### Example 1

In an exemplary scenario, the synthesis of Liₓ(Ni_{1-y-z}Mn_{y}Co_{z})₁₋ₐM′ₐO₂ is explained. In the embodiments of the present invention, the M′ is Al, Ti, and so forth. In the embodiments of the present invention, the value of “a” is 0<a≤0.05. In an embodiment of the present invention, the preparation of LiNi_{0.5}Mn_{0.25}Co_{0.2}Al_{0.025}Ti_{0.025}O₂ is done by combustion synthesis. The stoichiometric amounts nitrates of LiNO₃, Co(NO₃)₂·6H₂O, Ni(NO₃)₂·6H₂O, Mn(NO₃)₂·4H₂O, Al (NO₃)₃·9H₂O, TiO(NO₃)₂ and required amount of fuel (urea(80%)+glycine(20%)). Further, the molar ratio of Lithium:Metal nitrate:fuel be 1.1:1:1 respectively, and is dissolved in minimum amount of water and kept on the hot plate at 65° C. for few minutes to dissolve the salts completely. Moreover, the obtained clear solution of nitrates and fuel is transferred to an alumina crucible and introduced to a preheated furnace at 800° C. After combustion, the crucible is removed from the furnace and the sample is hand ground or ball milled and reheated at 850° C. for 12 h.

### Example 2

In an exemplary scenario, the synthesis of Liₓ(Ni_{1-y-z}Mn_{y}Co_{z})₁₋ₐM′ₐO₂ is explained. In the embodiments of the present invention, the M′ is Ti. In the embodiments of the present invention, the value of “a” is 0<a≤0.05. The preparation of LiNi_{0.5}Mn_{0.25}Co_{0.2}Ti_{0.05}O₂ is performed by combustion. The stoichiometric amounts nitrates of LiNO₃, Co(NO₃)₂·6H₂O, Ni(NO₃)₂·6H₂O, Mn(NO₃)₂·4H₂O, TiO(NO₃)₂ and required amount of fuel (urea(80%)+glycine(20%)). Further, the molar ratio of Lithium:Metal nitrate:fuel is 1.1:1:1 respectively, and further dissolved in minimum amount of water and kept on the hot plate at 70° C. for few minutes to dissolve the salts completely. The obtained clear solution of nitrates and fuel is transferred to an alumina crucible and introduced to a preheated furnace at 820° C. After combustion, the crucible is removed from the furnace and the sample is hand ground or ball milled and reheated at 850° C. for 12 h.

### Example 3

In an exemplary scenario, the synthesis of Liₓ(Ni_{1-y-z}Mn_{y}Co_{z})₁₋ₐM′ₐO₂ is explained. In the embodiments of the present invention, the M′ is Fe. In the embodiments of the present invention, the value of “a” is be 0<a≤0.05. The preparation of LiNi_{0.5}Mn_{0.25}Co_{0.2}Fe_{0.05}O₂ is done by combustion synthesis. In an embodiment of the present invention, the stoichiometric is amount nitrates of LiNO₃, Co(NO₃)₂·6H₂O, Ni(NO₃)₂·6H₂O, Mn(NO₃)₂·4H₂O, Fe(NO₃)₃·9H₂O and required amount of fuel (urea(80%)+glycine(20%)). The molar ratio of Lithium:Metal nitrate:fuel is 1.1:1:1 respectively, and is dissolved in minimum amount of water and kept on the hot plate at 60-80° C. for few minutes to dissolve the salts completely. Further, the obtained clear solution of nitrates and fuel is transferred to an alumina crucible and introduced to a preheated furnace at 850° C. After combustion, the crucible is removed from the furnace and the sample is hand ground or ball milled and reheated at 850° C. for 12 h.

### Example 4

In an exemplary scenario, the synthesis of Liₓ(Ni_{1-y-z}Mn_{y}Co_{z})₁₋ₐM′ₐO₂ is explained. In the embodiments of the present invention, the M′ is Cr. In the embodiments of the present invention, the value of “a” is 0<a≤0.05. The preparation of LiNi_{0.5}Mn_{0.25}Co_{0.2}Cr_{0.05}O₂ by combustion synthesis. The stoichiometric amounts nitrates of LiNO₃, Co(NO₃)₂·6H₂O, Ni(NO₃)₂·6H₂O, Mn(NO₃)₂·4H₂O, Cr(NO₃)₃·9H₂O and required amount of fuel (urea(80%)+glycine(20%)). The molar ratio of Lithium:Metal nitrate:fuel is 1.1:1:1 respectively and further dissolved in minimum amount of water and kept on the hot plate at 60-80° C. for few minutes to dissolve the salts completely. The obtained clear solution of nitrates and fuel is transferred to an alumina crucible and introduced to a preheated furnace at 780° C. After combustion, the crucible is removed from the furnace and the sample is hand ground or ball milled and reheated at 850° C. for 24 h.

This written description uses examples to disclose the invention, including the best mode, and also to enable any person skilled in the art to practice the invention, including making and using any devices or systems and performing any incorporated methods. The patentable scope the invention is defined in the claims, and include other examples that occur to those skilled in the art. Such other examples are intended to be within the scope of the claims if they have structural elements that do not differ from the literal language of the claims, or if they include equivalent structural elements within substantial differences from the literal languages of the claims.

### REFERENCE NUMERALS

### FIG. 1

1. 100—Cathode active material composition
2. 102—Precursors
3. 102a and 102n—n number of metal precursors
4. 104—Deionized water
5. 110—Container
6. 114—Hot plate
7. 116—Crucible
8. 118—Combustion furnace

### FIG. 2

1. 200—Lithium-ion battery
2. 202—Cathode
3. 204—Anode
4. 206—Electrolyte
5. 208—Separator
6. 210—First surface
7. 212—Second surface

### Advantages of the Invention

The main advantages of the present invention are:
1. The cathode active material composition is reproducible and consistent from batch to batch.
2. This invention is simple and cost-effective.
3. This invention is a quick process and easy for bulk production.
4. The active material composition offers improvement in the capacity, size distribution of particles, structural and surface area.
5. This active material composition can be utilized for battery industry.

We claim:

1. A cathode active material composition (100) for the Lithium-ion battery (200) having the formula Liₓ(Ni_{1-y-z}Mn_{y}Co_{z})₁₋ₐM′ₐO₂ wherein 1.0≤x≤1.1, 0.25≤y≤0.3, 0.15≤z≤0.2, and 0<a≤0.05 comprises:
particles having a size distribution of the particles in the range of 0.296 μm to 517.200 μm;
and a specific capacity ranging from 140 mAh/g to 161 mAh/g, wherein
the particles size distribution comprises a median size (D₅₀) indicating 500% of the particles in the sample lesser than the range of 5.6148 μm and 71.1594 μm and the remaining 50% greater than the range.

2. The cathode active material composition (100) as claimed in claim 1, wherein the element M′ is selected from Titanium (Ti), Aluminum (Al), Chromium (Cr), Iron (Fe), or a combination thereof.

3. The cathode active material composition (100) for the Lithium-ion battery (200) as claimed in claim 1, wherein cathode composition having formula Liₓ(Ni_{1-y-z}Mn_{y}Co_{z})₁₋ₐM′ₐO₂ and 1.0≤x≤1.1, 0.25≤y≤0.3, 0.15≤z≤0.2, 0<a≤0.05 comprises particles having a size distribution of the particles between 0.766 μm to 517.200 μm and a specific capacity ranging from 150 mAh/g to 161 mAh/g, wherein the particles size distribution comprise a median size (D₅₀) indicating 50% of the particles in the sample lesser than 71.1594 μm and the remaining 50% greater than the range.

4. The cathode active material composition (100) for the Lithium-ion battery (200) as claimed in claim 1, wherein the cathode composition having formula Liₓ(Ni_{1-y-z}Mn_{y}Co_{z})₁₋ₐM′ₐO₂ and 1.0≤x≤1.1, 0.25≤y≤0.3, 0.15≤z≤0.2, 0<a≤0.05 comprises particles having a size distribution of the particles between 0.339 μm to 200 μm and a specific capacity ranging from 140 mAh/g to 160 mAh/g, wherein the particles size distribution comprise a median size (D₅₀) indicating 50% of the particles in the sample lesser than 5.6148 μm and the remaining 50% greater than the range.

5. The cathode active material composition (100) for the Lithium-ion battery (200) as claimed in claim 1, wherein the cathode composition having formula Liₓ(Ni_{1-y-z}Mn_{y}Co_{z})₁₋ₐM′ₐO₂ and 1.0≤x≤1.1, 0.25≤y≤0.3, 0.15≤z≤0.2, 0<a≤0.05 comprises particles having a size distribution of the particles between 0.58 μm to 29.907 μm and a specific capacity ranging from 150 mAh/g to 155 mAh/g, wherein the particles size distribution comprise a median size (D₅₀) indicating 50% of the particles in a sample lesser than 8.6573 μm and the remaining 50% greater than the range.

6. The cathode active material composition (100) for the Lithium-ion battery (200) as claimed in claim 1, wherein the cathode composition having formula Liₓ(Ni_{1-y-z}Mn_{y}Co_{z})₁₋ₐM′ₐO₂ and 1.0≤x≤1.1, 0.25≤y≤0.3, 0.15≤z≤0.2, 0<a≤0.05 comprises particles having a size distribution of the particles between 0.296 μm to 262.376 μm and a specific capacity ranging from 148 mAh/g to 155 mAh/g, wherein the particles size distribution comprise a median size (D₅₀) indicating 50% of the particles in the sample lesser than 20.7721 μm and the remaining 50% greater than the range.

7. The cathode active material composition (100) as claimed in claim 1, wherein a surface area of the particles of the composition ranges from 1 m²/g to 10 m²/g.

8. The cathode active material composition (100) as claimed in claim 1, wherein a crystalline size of the particles of the composition ranges from 60 nm to 70 nm.

9. The cathode active material composition (100) as claimed in claim 1, wherein the composition is a layered crystal structure with a crystal space group of R3̅m.

10. A process for producing a cathode active material composition (100) as claimed in claim 1, for a lithium-ion battery (200) having a formula Liₓ(Ni_{1-y-z}Mn_{y}Co_{z})₁₋ₐM′ₐO₂ wherein 1.0<x<1.1, 0.25<y<0.3, 0.15<z<0.2, and 0<a<0.05, comprising the steps of:
i. dissolving precursors (102) in deionized water (104) in a container (110) to form a precursor solution, wherein the precursors (102) are metal-nitrate precursors;
ii. stirring the precursor solution in the container (110), wherein the precursor solution filled in the container (110) is heated at a temperature in a range of 60° C.-100° C.;
iii. adding organic amides and amino acids into the precursor solution to form a homogeneous solution in the container (110);
iv. pouring the obtained homogenous solution into a crucible (116) for performing combustion at a temperature in a range of 600° C.-1000° C. for a predefined time of 1 minute to 30 minutes to obtain a sample;
v. grinding the obtained sample for a predefined time of 10 minutes to 10 hours by a grinding unit after a cool down of the sample; and
vi. sintering the ground sample at a predetermined temperature in a range of 600° C.-1000° C. for a predefined time of 1 hour-24 hours to obtain the cathode active material composition (100).

11. Lithium-ion battery (200) comprises:
a cathode (202) acting as a positive terminal obtained by coating a blended slurry of cathode active material composition (100) as claimed in claim 1, along with conducting carbons and binder;
a binder in a N-Methyl-2-Pyrrolidone (NMP) solvent on an Aluminum foil;
an anode (204) acting as a negative terminal;
an electrolyte (206) for lithium-ion conduction;
a separator (208) to isolate the cathode (202) and the anode (204) placed in the electrolyte (206), wherein the separator (208) includes a first surface configured to be in contact with the cathode (202) and a second surface configured to be in contact with the anode (204).
